(19) United States
(12) Patent Application Publication
(10) Pub. No.: US 2006/0048652 A1
(43) Pub. Date: Mar. 9, 2006

(54) Cake decorating device

(76) Inventor: Heon-Sang Ahn, Gyunggi-do (KR)

Correspondence Address: GREENBLUM & BERNSTEIN, P.L.C., 1950 ROLAND CLARKE PLACE, RESTON, VA, 20191, US

(21) Appl. No.: 10/532,101

(22) PCT Filed: Sep. 23, 2003
(86) PCT No.: PCT/KR03/01925

§ 371 Date: Apr. 21, 2005

(30) Foreign Application Priority Data
Nov. 7, 2002 (KR) 10-2002-0068817

(51) Int. Cl. A23G 1/10

(52) U.S. Cl. 99/485

(57) ABSTRACT

Disclosed is a cake decorating device, suitable for producing a more dramatic and attractive atmosphere of the place where various celebratory events are held, while displaying a congratulation message or picture on the decorating device by heat conduction. The cake decorating device includes a base having locking grooves formed at an upper surface of the base, and a support plate having locking protrusions formed at a lower surface of the support plate to be fitted into the locking grooves of the base. The support plate has a plurality of candles. Also, a transfer paper having a message printed using a thermosensitive microcapsule product is attached onto a wall of the base, whereby the message can be displayed by heat conduction of the candles. Thus, the atmosphere of the celebratory event is beautifully produced and reaches the climax by the cake decorating device.

### BACKGROUND OF THE INVENTION

1. Field of the Invention

The present invention pertains, in general, to cake decorating devices, and, more specifically, to a cake decorating device for use in producing a more dramatic and attractive atmosphere of the place where various celebratory events, such as birthdays or anniversaries, are held, through a congratulation message or picture to be heat-transferred.

2. Description of the Related Art

With great advances in economies, a social atmosphere for pursuing the latitude of life is gradually spread. Accordingly, while people have much in reserve, various parties or events are generally held. In such a case, as accessories necessary for celebratory events, such as birthdays or weddings, cakes are essentially used to express congratulation.

Upon buying cakes, cake candles, knifes, firecrackers, and cards are provided along with the cakes, which are useful to create a festive atmosphere of the event.

However, limitations are imposed on producing such an atmosphere by conventional cake accessories. This is because only a few candles are provided upon buying the cake. Accordingly, it is difficult to produce more beautiful and various atmospheres by candlelight resulting from several candles.

Further, when the cake is bought, other event accessories are not provided in addition to candles and firecrackers. Hence, more pleasant and mysterious atmospheres during the celebratory events cannot be produced.

### SUMMARY OF THE INVENTION

Therefore, it is an aspect of the present invention to alleviate the problems encountered in the related art and to provide a cake decorating device, characterized in that a congratulation message screening on a transfer paper is gradually displayed by heat conduction, whereby the atmosphere of the place where various celebratory events are held reaches the climax.

Another aspect of the present invention is to provide a cake decorating device, capable of producing more pleasant and various atmospheres through a variously shaped base, a support plate and candlelight by a plurality of candles.

To accomplish the above aspects, there is provided a cake decorating device, including a base having a support pin at a lower surface thereof to be pinned on a cake, a heating unit mounted to the base to emit heat, and a displaying unit provided on a vertical wall of the base to show a previously printed message by heat conduction of the heating unit.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 shows a perspective view of a cake decorating device, according to a first embodiment of the present invention;

FIG. 2 shows a front view of the cake decorating device of FIG. 1;

FIG. 3 shows the cake decorating device of FIG. 1 when being practically used;

FIG. 4 shows a perspective view of a heating unit of a cake decorating device, according to a second embodiment of the present invention;

FIG. 5 shows a perspective view of a heating unit of a cake decorating device, according to a third embodiment of the present invention;

FIG. 6 shows a perspective view of a heating unit of a cake decorating device, according to a fourth embodiment of the present invention;

FIG. 7 shows a perspective view of a heating unit of a cake decorating device, according to a fifth embodiment of the present invention; and

FIG. 8 shows a perspective view of a heating unit of a cake decorating device, according to a sixth embodiment of the present invention.

### DETAILED DESCRIPTION OF THE INVENTION

Hereinafter, a detailed description will be given of a cake decorating device according to preferred embodiments of the present invention, in conjunction with the accompanying drawings.

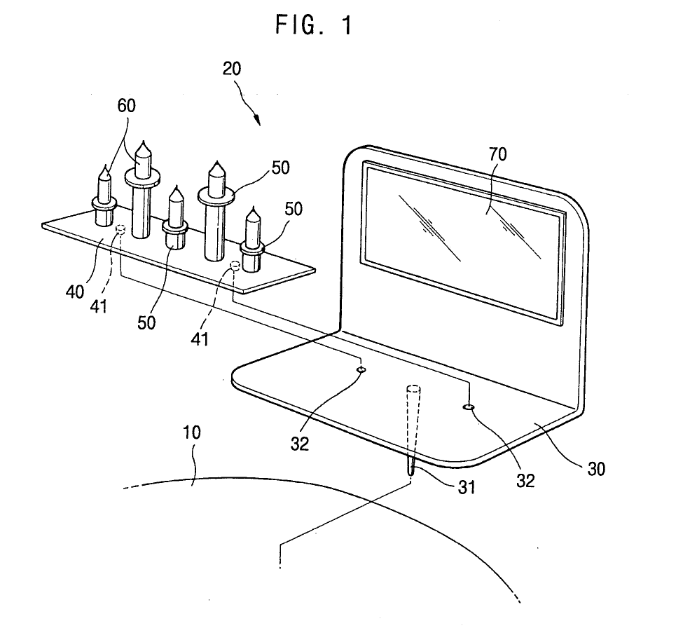

As shown in FIGS. 1 through 3, a cake decorating device largely includes a base 30, a heating unit, and a displaying unit, in which the base 30 has a support pin 31 at a lower surface of the base 30 to be easily provided on the cake, and locking grooves 32 at both upper sides of the base 30.

The heating unit is used to transfer heat to the displaying unit, through which the atmosphere of the place where a celebratory event is held reaches the climax. With reference to FIG. 1, there is shown the heating unit of the cake decorating device according to a first embodiment of the present invention. Further, locking protrusions 41 are formed at a lower surface of a support plate 40, corresponding to each position of the locking grooves 32, and fitted into the locking grooves 32 of the base 30.

On the support plate 40, a plurality of candlesticks 50 each having a candle 60 are mounted. Candlelight provided by the candle 60 that is placed on each candlestick 50 functions to transfer heat to the displaying unit, and as well, to produce a graceful and mysterious atmosphere, whereby the atmosphere of the celebratory events, such as birthdays or anniversaries, is beautifully created.

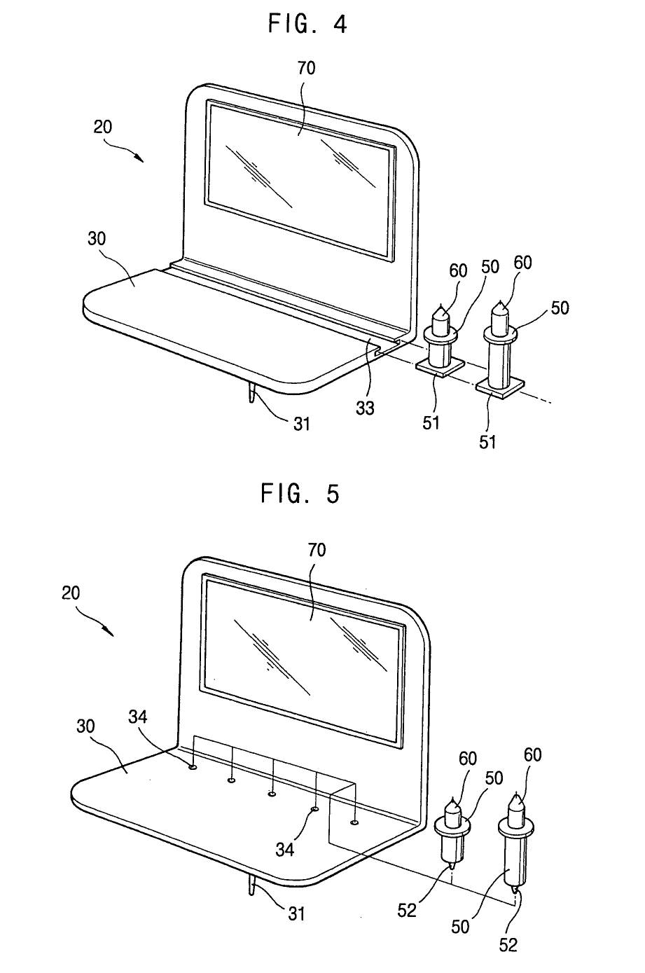

FIG. 4 shows a heating unit of a cake decorating device according to a second embodiment of the present invention, in which a rail groove 33 is formed at an upper surface of a base 30. In addition, a locking part 51 is formed at a lower surface of each candlestick 50 to be fitted into the rail groove 33 of the base 30. Also, a candle 60 is provided to each candlestick 50, as in the first embodiment.

Thus, heat resulting from the candle 60 placed on the candlestick 50 is transferred to a transfer paper 70. According to the second embodiment, the candlestick 50 can be freely moved along the rail groove 33, and thus the candlestick 50 is easily controlled in the position thereof and readily assembled to the base 30.

FIG. 5 shows a heating unit of a cake decorating device according to a third embodiment of the present invention, in which a plurality of locking holes 34 are aligned parallel to one another onto an upper surface of a base 30. Further, a locking pin 52 formed at a lower surface of each candlestick 50 is fitted into the locking hole 34 of the base 30.

Hence, a transfer paper 70 is heated by a burning candle 60 of the candlestick 50 fitted into the locking hole 34 of the base 30. According to the third embodiment, the candlestick 50 is simply pinned into the locking hole 34, whereby it can be easily provided on the cake.

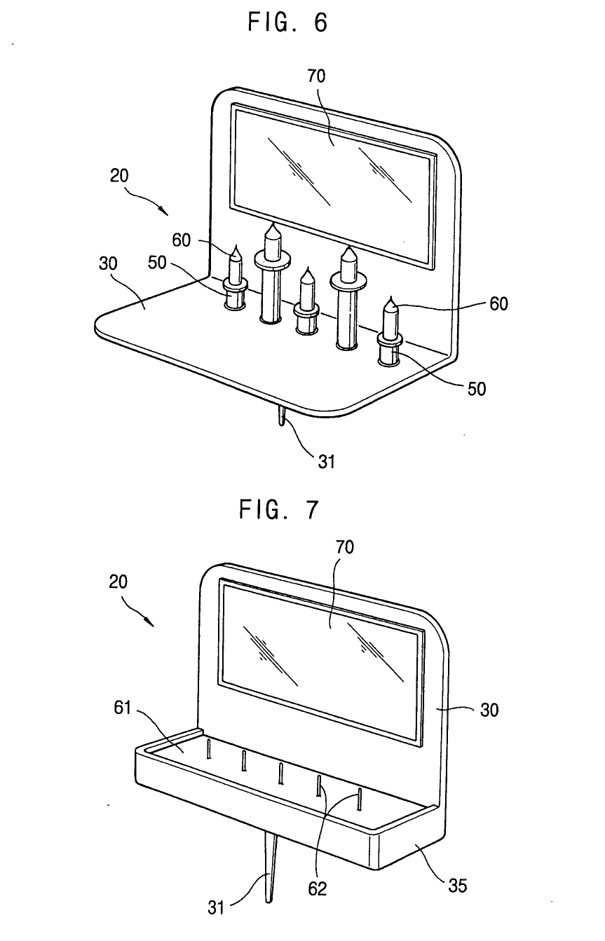

FIG. 6 shows a heating unit of a cake decorating device according to a fourth embodiment of the present invention, in which a plurality of candlesticks 50 each having a candle 60 are adhered onto an upper surface of a base 30. Hence, a transfer paper 70 is heated by the flame of each candle 60 placed on a plurality of the candlesticks 50 that are adhered onto the base 30. According to the fourth embodiment, a plurality of the candlesticks 50 and a plurality of the candles 60 can be stably mounted to the base 30.

FIG. 7 shows a heating unit of a cake decorating device according to a fifth embodiment of the present invention, in which a candle-receiving chamber 35 is formed in the front of a base 30. Also, in the candle-receiving chamber 35, a candle 61 having a plurality of candlewicks 62 is placed. Hence, a transfer paper 70 attached to a wall of the base 30 is heated by the flame of the candle 61 placed in the candle-receiving chamber 35. According to the fifth embodiment, there are not required a plurality of candlesticks 50 and a plurality of candles 60 as in the first through fourth embodiments, and thus the number of necessary parts decreases and an assembling process of a product is simplified.

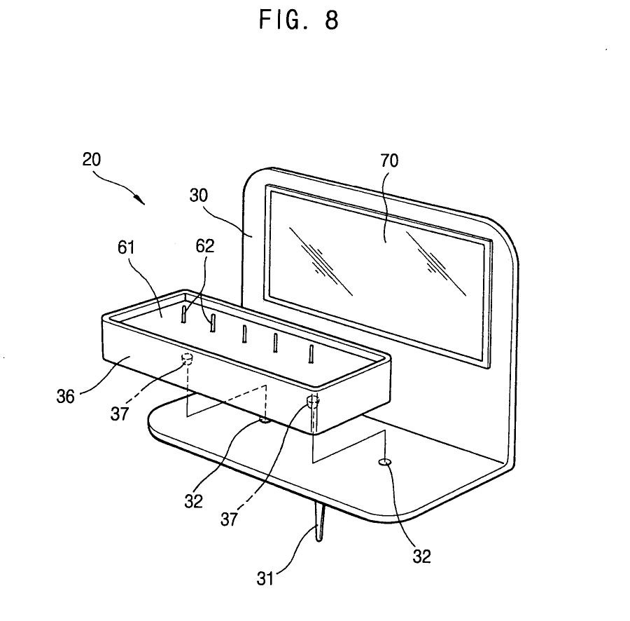

FIG. 8 shows a heating unit of a cake decorating device according to a sixth embodiment of the present invention, in which a removable candle-receiving chamber 36 is mounted to an upper surface of a base 30. In the candle-receiving chamber 36, a candle 61 having a plurality of candlewicks 62 is placed. Further, locking protrusions 37 are formed at both bottom sides of the candle-receiving chamber 36, and fitted into locking grooves 32 formed at an upper surface of the base 30.

Hence, a transfer paper 70 attached to a wall of the base 30 is heated by the burning candle 61 placed in the candle-receiving chamber 36, as in the fifth embodiment. According to the sixth embodiment, there are not required a plurality of candlesticks 50 and a plurality of candles 60 as in the first through fourth embodiments, and thus the number of necessary parts decreases and an assembling process of a product is simplified.

In the fifth and sixth embodiments, although the heating unit of the cake decorating device is mounted only in the front of the wall of the base 30, it may be mounted in the rear thereof, as well as the front of the base 30, if necessary.

On the other hand, the displaying unit is attached onto the wall of the base 30, and functions to show a screening congratulation message by heat conduction of the heating unit. In the present invention, the transfer paper 70 prepared by using a thermosensitive microcapsule product is applied.

To include the wording for congratulations of celebrations, such as birthdays or anniversaries, a printing process is previously performed onto the transfer paper 70, by use of the thermosensitive microcapsule product. When heat is transferred to the transfer paper 70 by the flame of the candle of the heating unit, the congratulation wording printed previously on the transfer paper 70 is gradually displayed. Thereby, the atmosphere of the place where the celebratory event is held reaches the climax.

As for the thermosensitive microcapsule product, predetermined colors of thermosensitive microcapsules are changed to different colors, colorlessness, or background colors, when the thermosensitve microcapsules are heated to be higher than predetermined temperatures. Whereas, when the thermosensitive microcapsules are cooled to be lower than predetermined temperatures, the changed colors thereof are restored to the original colors.

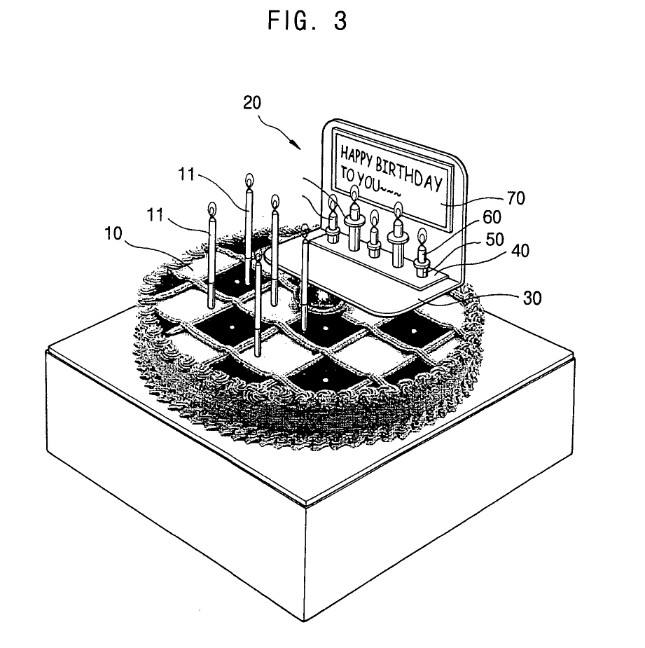

Therefore, in the present invention, the transfer paper 70 is subjected to a printing process by use of an ink product formed of the thermosensitive microcapsules, so that it includes the message or picture for congratulations of celebrations, such as birthdays or anniversaries. When heat is conducted to the transfer paper 70 by the heating unit, the previously printed congratulation message on the transfer paper 70 is displayed as in FIG. 3, whereby the atmosphere of the celebratory event reaches the climax.

Below, functions and effects of the cake decorating device of the present invention are described, based on the heating unit of the base 30 of the cake decorating device according to the first embodiment.

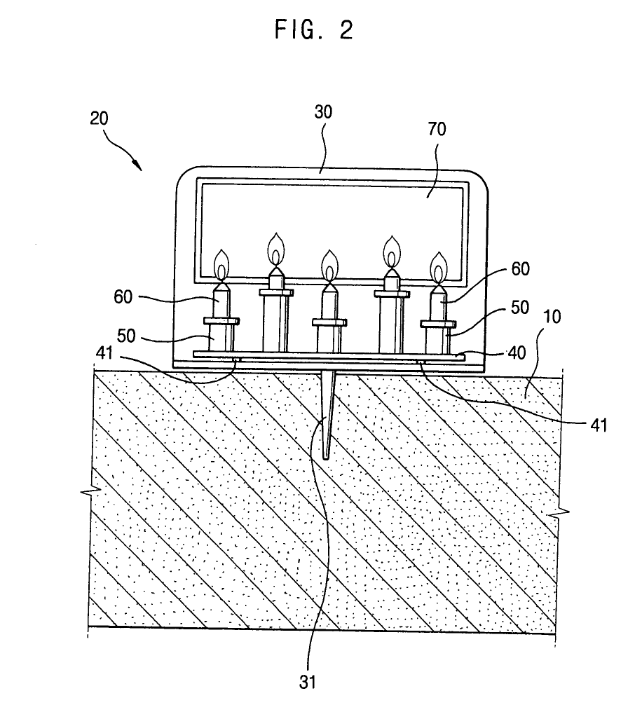

For the birthday or anniversary ceremonies, candles 11 are pinned on a cake 10. As such, a cake decorating device 20 for showing messages is mounted on the cake 10, as shown in FIGS. 2 and 3.

That is, the decorating device 20 is pinned on the cake by use of the support pin 31 formed at the lower surface of the base 30 of the decorating device 20, followed by lighting the candlelight by the candles 60. While the candles 60 are burning, heat is transferred from the flame of the candles 60 to the transfer paper 70, whereby a message screening on the transfer paper 70 is externally displayed by heat conduction, as shown in FIG. 3.

Hence, as the message is displayed by heat conduction, the atmosphere of the place where the celebratory event is held reaches the climax. In particular, those attending the celebratory event are impressed while viewing the gradually displaying message by heat conduction.

Further, a predetermined period after the candlelight is brightened, the message printed on the transfer paper 70 is displayed while, say, a festive song is sung, or a congratulation message is read. Thus, in the joyful atmosphere, since the screening message is displayed, the atmosphere of the celebratory event reaches the climax.

In addition, since the decorating device 20 adopts a manner of displaying the screening message by the heat conduction of the heating unit, all the persons participated in the parties are interested in such a gradually showing message and thus can concentrate on the celebratory event.

Moreover, the fundamental functions and effects of a heating unit of each cake decorating device shown in FIGS. 4 through 8 remain the same as in the first embodiment.

The decorating device 20 for showing the message has various decorating functions by means of the base 30 and the heating unit, in addition to the function of displaying the screening message by heat conduction.

That is, the base 30 is variously shaped according to the characteristics of celebratory events, and acts to produce a pleasant atmosphere of the celebratory events. In addition, advertisements of the manufacturing companies may be inserted, whereby the base 30 serves as an advertising means of products.

Also, the decorating device 20 includes the heating unit provided with a support plate 40, candlesticks 50 and candlelight of candles 60, in addition to the candles 11 pinned on the cake 10, whereby the atmosphere of the celebratory event is mysteriously and beautifully produced.

Conventionally, using the candles 11 provided upon buying the cake 10, the cake is decorated. Thus, limitations are imposed on producing the atmosphere of the event place. However, in the present invention, a decorative support plate 40 and a plurality of candles 60 provided by the heating unit, in addition to the candles 11 pinned on the cake 10, functions to produce a more beautiful and mysterious atmosphere of the event place.

As for the cake decorating device 20, guttered candle wax of candles 60 and 61 are surely prevented from dropping onto the surface of the cake 10, by means of the support plate 40, the base 30 and the candle-receiving chamber 35 and 36. Thus, after the birthday or anniversary ceremonies, the cake 10 can be deliciously eaten without concern about whether the guttered candle wax is dropped on the surface of the cake.

As described above, the present invention provides a cake decorating device, characterized in that a message screening on a transfer paper can be displayed by heat conduction of a heating unit, whereby the atmosphere of the place where a celebratory event is held is more mysteriously and beautifully produced and reaches the climax.

In the present invention, since the screening message is displayed by the heat conduction of the heating unit, all the persons participated in the event can concentrate on the celebratory event with mysterious and favorable feelings.

The cake decorating device includes a base capable of having various shapes, a support plate, a plurality of candlesticks, and a candle or a plurality of candles, whereby more beautiful events are produced. Further, advertisements may be inserted to the base and the transfer paper of the cake decorating device, which may be used for product information.

The present invention has been described in an illustrative manner, and it should be understood that the terminology used is intended to be in the nature of description rather than of limitation. Many modifications and variations of the present invention are possible in light of the above teachings. For example, the base may be variously shaped according to the characteristics of events for birthday or anniversary. Therefore, it should be understood that within the scope of the appended claims, the invention may be practiced otherwise than as specifically described.

What is claimed is:

1. A cake decorating device, comprising:
a base having a support pin at a lower surface thereof to be pinned on a cake;
a heating unit mounted to the base to emit heat; and
a displaying unit provided on a vertical wall of the base to show a previously printed message by heat conduction of the heating unit.

2. The cake decorating device as defined in claim 1, wherein the heating unit comprises
a support plate mounted to an upper surface of the base;
at least one candlestick provided on the support plate; and
a candle placed on the candlesticks.

3. The cake decorating device as defined in claim 1, wherein the heating unit comprises
a base having a rail groove thereon;
at least one candlesticks having a locking part at a lower surface thereof to be fitted into the rail groove of the base; and
a candle placed on the candlesticks.

4. The cake decorating device as defined in claim 1, wherein the heating unit comprises
a base having a plurality of locking holes thereon;
at least one candlestick having a locking pin at a lower surface thereof to be fitted into each of the locking holes of the base; and
a candle placed on the candlestick.

5. The cake decorating device as defined in claim 1, wherein the heating unit comprises a plurality of candlesticks each provided with a candle, and adhered onto an upper surface of the base.

6. The cake decorating device as defined in claim 1, wherein the heating unit comprises
a candle-receiving chamber integrated with the base; and
a candle having a plurality of candlewicks and received in the candle-receiving chamber.

7. The cake decorating device as defined in claim 1, wherein the heating unit comprises
a candle-receiving chamber provided on an upper surface of the base; and
a candle having a plurality of candlewicks and received in the candle-receiving chamber.

8. The cake decorating device as defined in claim 1, wherein the displaying unit comprises a transfer paper printed by a thermosensitive microcapsule product.
